(19) United States
(12) Patent Application Publication
(10) Pub. No.: US 2019/0061272 A1
(43) Pub. Date: Feb. 28, 2019

(54) METHOD FOR LASER WELDING OF NON-TRANSMISSIVE COMPOSITE MATERIALS

(71) Applicant: GM GLOBAL TECHNOLOGY OPERATIONS LLC, Detroit, MI (US)

(72) Inventors: Hongliang Wang, Sterling Heights, MI (US); Guoxian Xiao, Troy, MI (US); Hua-tzu Fan, Troy, MI (US); Jorge F. Arinez, Rochester Hills, MI (US)

(73) Assignee: GM GLOBAL TECHNOLOGY OPERATIONS LLC, Detroit, MI (US)

(21) Appl. No.: 15/688,361

(22) Filed: Aug. 28, 2017

(51) Int. Cl. B29C 65/16; B29C 65/00

(52) U.S. Cl. CPC B29C 65/1635; B29C 66/43; B29K 2101/12; B29C 66/02245; B29C 66/72323; B29C 66/02241

(57) ABSTRACT

A method for laser welding of non-transmissive composite materials includes: forming an energy channel having an end opening and extending through a first part made of a first material; and welding a second part made of a second material to the first part via laser heating of the materials of the first and second parts proximate to the end opening of the energy channel such that the materials of the first and second parts fuse to form a weld nugget, attaching the first part to the second part.

### INTRODUCTION

A laser beam may be used to weld a first part made of a thermoplastic composite material to a second part made of a similar material at a weld interface between the parts. When the weld interface is not at an edge of one of the parts, the composite material must be transmissive to the electromagnetic energy of the laser beam so that the laser beam can pass through the first part to reach the weld interface. For example, the transmissive composite material may include a transparent thermoplastic reinforced with transparent glass fibers so that the composite material is transmissive to the electromagnetic energy of the laser beam. A non-transmissive composite material prevents the electromagnetic energy of the laser beam from reaching the weld interface between the parts, making the weld difficult to achieve. For example, the non-transmissive composite material may include a thermoplastic material reinforced with non-transmissive carbon fibers so that the composite material is non-transmissive to the electromagnetic energy of the laser beam.

### SUMMARY

A method for laser welding of non-transmissive composite materials is disclosed herein. A first example method for laser welding of non-transmissive composite materials includes: forming an energy channel having an end opening and extending through a first part made of a first material; and welding a second part made of a second material to the first part via laser heating of the materials of the first and second parts proximate to the end opening of the energy channel such that the materials of the first and second parts fuse to form a weld nugget, attaching the first part to the second part.

The method may include positioning the first part relative to the second part such that a first surface of the first part is proximate to a second surface of the second part adjacent to the end opening of the first part. The method may include clamping the first part to the second part such that the first surface of the first part is in contact with the second surface of the second part adjacent to the end opening of the first part.

The first material may be non-transmissive to laser energy. The first material may be a carbon fiber reinforced thermoplastic composite material. The second material may be non-transmissive to laser energy. The second material may be the same as the first material.

Forming the energy channel may include laser ablation of the first material of the first part. Forming the energy channel may include one of molding, drilling, and water jet cutting. The energy channel may have an axis. The axis of the energy channel may be normal to the first surface. The axis of the energy channel may be not normal to the first surface.

The method may include placing an insert between the first surface of the first part and the second surface of the second part. The insert may extend at least across the end opening of the energy channel. The insert may include a thermoplastic material. Welding the second part to the first part via laser heating may include laser heating of the thermoplastic material of the insert such that the materials of the first part, the second part, and the insert fuse to form the weld nugget.

The insert may include a metal material. Welding the second part to the first part via laser heating may include laser heating of the metal material of the insert such that the materials of the first and second parts are heated by the insert and form bonding nuggets attached to the metal insert.

Forming the energy channel may include forming a multiplicity of energy channels. Welding may include forming a multiplicity of weld nuggets, attaching the first part to the second part. The multiplicity of energy channels may be formed in a pattern including one of a circular, a rectangular, a linear, and a wave pattern. Forming the energy channel may include forming the multiplicity of energy channels simultaneously. Welding may include forming a multiplicity of weld nuggets simultaneously, attaching the first part to the second part.

A second example method for laser welding of non-transmissive composite materials includes: forming an energy channel extending through a first part and having an end opening; positioning the first part relative to a second part such that a first surface of the first part is proximate to a second surface of the second part adjacent to the end opening of the energy channel; and welding the second part to the first part via laser heating of the first and second parts proximate to the end opening of the energy channel such that the first and second parts fuse to form a weld nugget. The first part is made of a first material that is non-transmissive to laser energy and includes a thermoplastic material. The second part is made of a second material that includes a thermoplastic material.

A third example method for laser welding of non-transmissive composite materials includes: forming an energy channel extending through a first part and having an end opening; placing an insert between a first surface of the first part and a second surface of a second part; and welding the second part to the first part via laser heating of the insert, the first part, and the second part proximate to the end opening of the energy channel such that at least one weld nugget is formed, attaching the first part to the second part. The first part is made of a first material that is non-transmissive to laser energy and includes a thermoplastic material. The second part is made of a second material that includes a thermoplastic material.

The insert may include a metal material. Forming the energy channel and welding the second part to the first part may occur during a single burst of laser energy. The at least one weld nugget may attach the first and second parts to the metal insert such that the first part is attached to the second part via the metal insert.

The method disclosed herein enables laser welding of parts made of composite materials that are non-transmissive to the electromagnetic energy of a laser beam. The method enables laser welding remote from the edges of the parts with minimum effect on the surface appearance of the parts. This disclosure applies to welding of thermoplastic composite parts for a vehicle, including but not limited to cars, trucks, vans, all-terrain vehicles, busses, boats, trains, airplanes, manufacturing vehicles and equipment, construction vehicles and equipment, maintenance vehicles and equipment, etc. This disclosure applies to welding of thermoplastic composite parts for a machine or manufacture.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a fragmentary, schematic, perspective illustration of a first part attached to a second part via a laser weld that is made using a method for laser welding of non-transmissive composite materials of the type disclosed herein.

FIG. 2 is a flowchart of an example method for laser welding of non-transmissive composite materials of the type disclosed herein.

FIG. 3A is a fragmentary, schematic, cross-sectional view of the first part and the second part of FIG. 1, in the area of the laser weld, as an energy channel is being formed in the first part via laser ablation.

FIG. 3B is a fragmentary, schematic, cross-sectional view of the first part and the second part of FIG. 1, in the area of the laser weld, after the energy channel has been formed in the first part.

FIG. 3C is a fragmentary, schematic, cross-sectional view of the first part and the second part of FIG. 1, in the area of the laser weld, as the first part is being welded to the second part via laser heating.

FIG. 3D is a fragmentary, schematic, cross-sectional view of the first part and the second part of FIG. 1, in the area of the laser weld, after the first part is welded to the second part via laser heating, showing the weld nugget attaching the first part to the second part.

FIG. 4A is a fragmentary, schematic, cross-sectional view of the first part and the second part of FIG. 1, in the area of the laser weld, as an angled energy channel is being formed in the first part via laser ablation.

FIG. 4B is a fragmentary, schematic, cross-sectional view of the first part and the second part of FIG. 4A, in the area of the laser weld, after the angled energy channel has been formed in the first part.

FIG. 4C is a fragmentary, schematic, cross-sectional view of the first part and the second part of FIG. 4A, in the area of the laser weld, as the first part is being welded to the second part via laser heating.

FIG. 4D is a fragmentary, schematic, cross-sectional view of the first part and the second part of FIG. 4A, in the area of the laser weld, after the first part is welded to the second part via laser heating, showing the weld nugget attaching the first part to the second part.

FIG. 5A is a fragmentary, schematic, cross-sectional view of the first part and the second part of FIG. 1, in the area of the laser weld, including a thermoplastic insert between the two parts, as an energy channel is being formed in the first part via laser ablation.

FIG. 5B is a fragmentary, schematic, cross-sectional view of the first part, the second part, and the thermoplastic insert of FIG. 5A, in the area of the laser weld, after the energy channel has been formed in the first part.

FIG. 5C is a fragmentary, schematic, cross-sectional view of the first part, the second part, and the thermoplastic insert of FIG. 5A, in the area of the laser weld, as the first part, the second part, and the thermoplastic insert are being welded together via laser heating.

FIG. 5D is a fragmentary, schematic, cross-sectional view of the first part, the second part, and the thermoplastic insert of FIG. 5A, in the area of the laser weld, after the first part, the second part, and the thermoplastic insert are welded together via laser heating, showing the weld nugget attaching the first part to the second part.

FIG. 6A is a fragmentary, schematic, cross-sectional view of the first part and the second part of FIG. 1, in the area of the laser weld, including an metal insert between the two parts, as an energy channel is being formed in the first part and the first and second parts are being welded to the metal insert.

FIG. 6B is a fragmentary, schematic, cross-sectional view of the first part, the second part, and the metal insert of FIG. 6A, in the area of the laser weld, after the first and second parts are welded to the metal insert, showing the weld nuggets attaching the first part to the second part.

FIG. 7A is a fragmentary, schematic, top view illustration of the first part of FIG. 1, in the area of the laser weld, showing a circular pattern of energy channels formed in the first part.

FIG. 7B is a fragmentary, schematic, top view illustration of the first part of FIG. 1, in the area of the laser weld, showing a rectangular pattern of energy channels formed in the first part.

FIG. 7C is a fragmentary, schematic, top view illustration of the first part of FIG. 1, in the area of the laser weld, showing a linear pattern of energy channels formed in the first part.

FIG. 7D is a fragmentary, schematic, top view illustration of the first part of FIG. 1, in the area of the laser weld, showing a curved pattern of energy channels formed in the first part.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

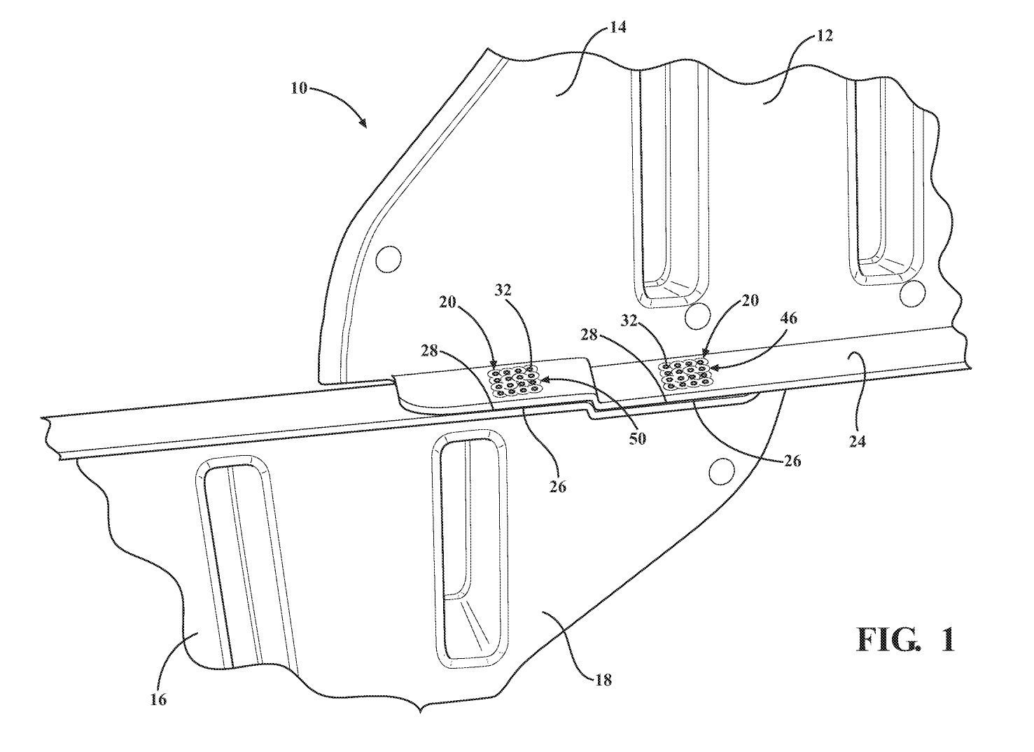

Referring to the drawings, wherein like reference numbers refer to like components throughout the views, FIG. 1 shows a portion of a vehicle 10 including a first part 12 made of a first material 14 attached to a second part 16 made of a second material 18 via a laser weld 20. The laser weld 20 is made using a method 100 for laser welding of non-transmissive composite materials. Non-limiting examples of the first and second parts 12, 16 include structural members, exterior panels, load floors, and interior panels of the vehicle 10 or of another machine or manufacture.

One or both of the first and second materials 14, 18 may be non-transmissive to the electromagnetic energy of a laser beam 22. One or both of the first and second materials 14, 18 may include a thermoplastic material. One or both of the first and second materials 14, 18 may include a thermoplastic material that is non-transmissive to the electromagnetic energy of the laser beam 22. One or both of the first and second materials 14, 18 may be a composite material that is non-transmissive to the electromagnetic energy of the laser beam 22. For example, one or both of the first and second materials 14, 18 may include a thermoplastic material reinforced with a carbon fiber material that is non-transmissive to the electromagnetic energy of the laser beam. The first material 14 may be non-transmissive to the electromagnetic energy of the laser beam 22. The first material 14 may be a carbon fiber reinforced thermoplastic composite material. The second material 18 may be the same as the first material 14.

“Non-transmissive” is defined herein as impenetrable or opaque to the electromagnetic energy of the laser beam 22. “Composite material” is defined herein as a material that includes at least two distinct materials, for example a thermoplastic material reinforced with a carbon fiber material.

The first part 12 includes an outer surface 24 and an inner, weld, or first surface 26. The second part 16 includes an inner, weld, or second surface 28. The first and second surfaces 26, 28 may be in close proximity or in contact at a weld interface 30 formed between the first and second parts 12, 16.

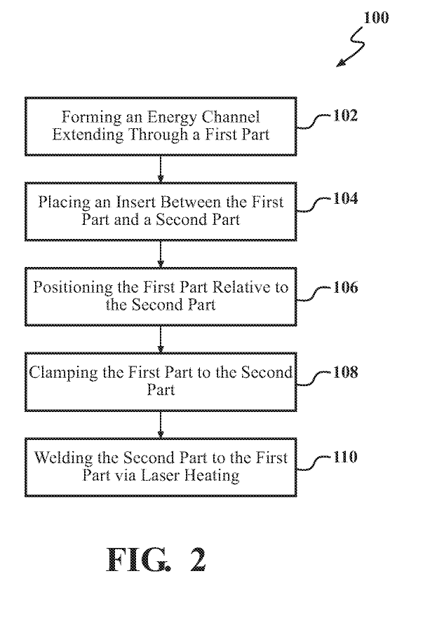

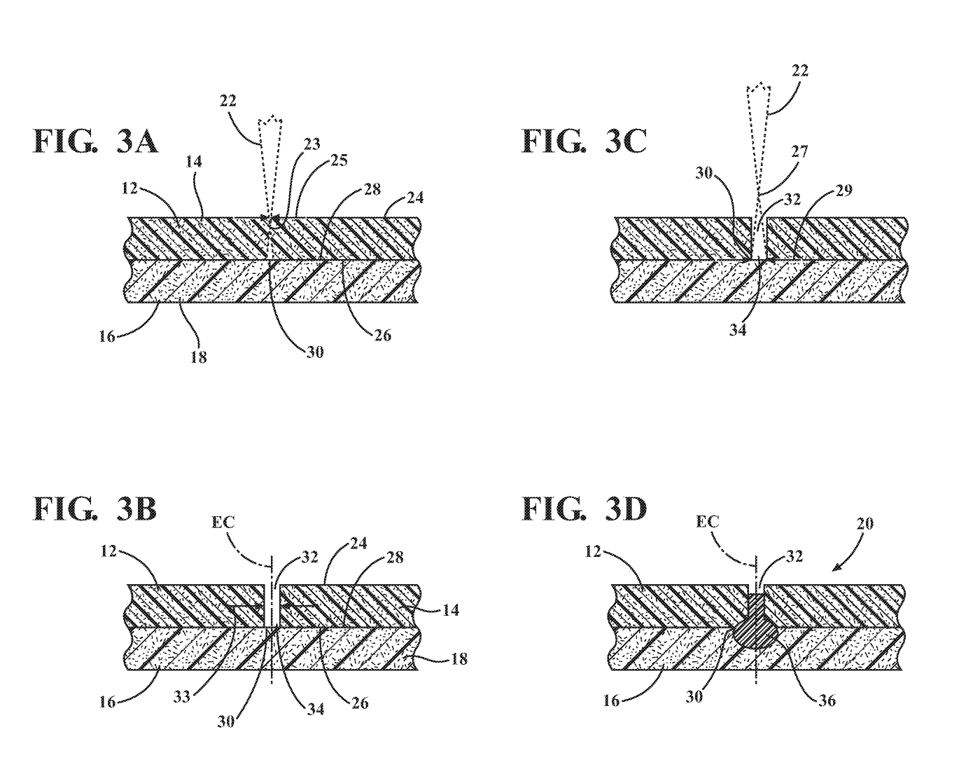

Referring now to FIGS. 2-6B, the method 100 for laser welding of non-transmissive composite materials includes, at step 102, forming an energy channel 32 having an end opening 34 at the first surface 26 of the first part 12 and extending through the first part 12 made of the first material 14. The energy channel 32 may be formed by laser ablation via the laser beam 22 to ablate or remove the first material 14 of the first part 12 to form the energy channel 32, as best seen in FIGS. 3A, 4A, 5A, and 6A. The energy channel 32 may be cylindrical in shape, as best seen in FIGS. 3B, 4B, and 5B. Alternatively, the energy channel 32 may be formed via drilling, punching, water jet cutting, or molding. The energy channel 32 may have a diameter 33. The diameter 33 of the energy channel 32 may be approximately 2 mm. The diameter 33 of the energy channel 32 may be less than 3 mm.

Referring now to FIGS. 3A, 4A, 5A, and 6A, at step 102, the laser beam 22 may be configured for laser ablation. The laser beam 22 may be operated at a high power during laser ablation. For example, the laser beam 22 may be operated at 1200 Watts or more during laser ablation. The laser beam 22 may be focused at an ablation focal point 23 at or proximate to the outer surface 24 of the first part 12 during laser ablation, as shown. The laser beam 22 may have a small ablation diameter 25 at the outer surface 24 of the first part 12 during laser ablation. The laser beam 22 may have an ablation diameter 25 of approximately 0.1 mm or less during laser ablation. Alternatively, the laser beam 22 may have an ablation diameter 25 of approximately 1 mm or less during laser ablation. The laser beam 22 may oscillate in a circle (not shown) on the outer surface 24 of the first part 12 during laser ablation. The laser beam 22 may oscillate in an approximately 2 mm diameter circle on the outer surface 24 of the first part 12 during laser ablation. The laser beam 22 may oscillate in a circle less than approximately 3 mm in diameter on the outer surface 24 of the first part 12 during laser ablation.

Referring again to FIGS. 2-6B, the method 100 also includes, at step 110, welding the second part 16 made of the second material 18 to the first part 12 via laser heating of the materials 14, 18 of the first and second parts 12, 16 proximate to the end opening 34 of the energy channel 22 such that the materials 14, 18 of the first and second parts 12, 16 proximate to the end opening 34 of the energy channel 32 fuse to form a weld nugget 36, attaching the first part 12 to the second part 16 via the weld nugget 26. The first material 14 of the first part 12 is removed from the energy channel 32 formed in the first part 12 during laser ablation so that the electromagnetic energy of the laser beam 22 passes through the energy channel 32 and reaches the first and second materials 14, 18 at the weld interface 30, as best seen in FIGS. 3C, 4C, and 5C. The resulting weld nugget 36, is best seen in FIGS. 3D, 4D, 5D, and 6B.

“Fuse” is defined herein as combine or blend by melting together the materials of two or more parts. “Weld nugget” is defined herein as the portion of the two or more parts where the materials of the parts are fused.

Referring now to FIGS. 3C, 4C, and 5C, at step 110 the laser beam 22 may be configured for laser welding. The laser beam 22 may be operated at a low power during laser welding. For example, the laser beam 22 may be operated at 400 Watts or less during laser welding. The laser beam 22 may be focused at a welding focal point 27 above the outer surface 24 of the first part 12 or outside of the first part 12 during laser welding, as shown. The laser beam 22 may have a welding diameter 29 at the end opening 34 of the energy channel 32 that is the same as the diameter 33 of the energy channel 32 during laser welding. The laser beam 22 may have a welding diameter 29 at the end opening 34 of the energy channel 32 that is larger than the diameter 33 of the energy channel 32 during laser welding. The laser beam 22 may have a welding diameter 29 of 2 mm or more during laser welding. The laser beam 22 may have a welding diameter 29 of approximately 3 mm during laser welding. The laser beam 22 may not oscillate in a circle during laser welding.

One laser device (not shown) may generate both the laser beam 22 configured for laser ablation and the laser beam 22 configured for laser welding. The laser weld 20, may be a spot weld, as shown in FIGS. 1, 3D, 4D, 5D, and 6B. Alternatively, the laser weld 20 may be a continuous or line weld having a continuous weld nugget (not shown). The continuous or line weld may be straight or curved in shape.

Referring again to FIGS. 2-6B, the method 100 may include, at step 106, positioning the first part 12 relative to the second part 16 such that the first surface 26 of the first part 12 is proximate to the second surface 28 of the second part 16 adjacent to the end opening 34 of the energy channel 32 of the first part 12. The method 100, may include, at step 108, clamping the first part 12 to the second part 16 such that the first surface 26 of the first part 12 is in contact with the second surface 28 of the second part 16 adjacent to the end opening 34 of the energy channel 32 of the first part 12.

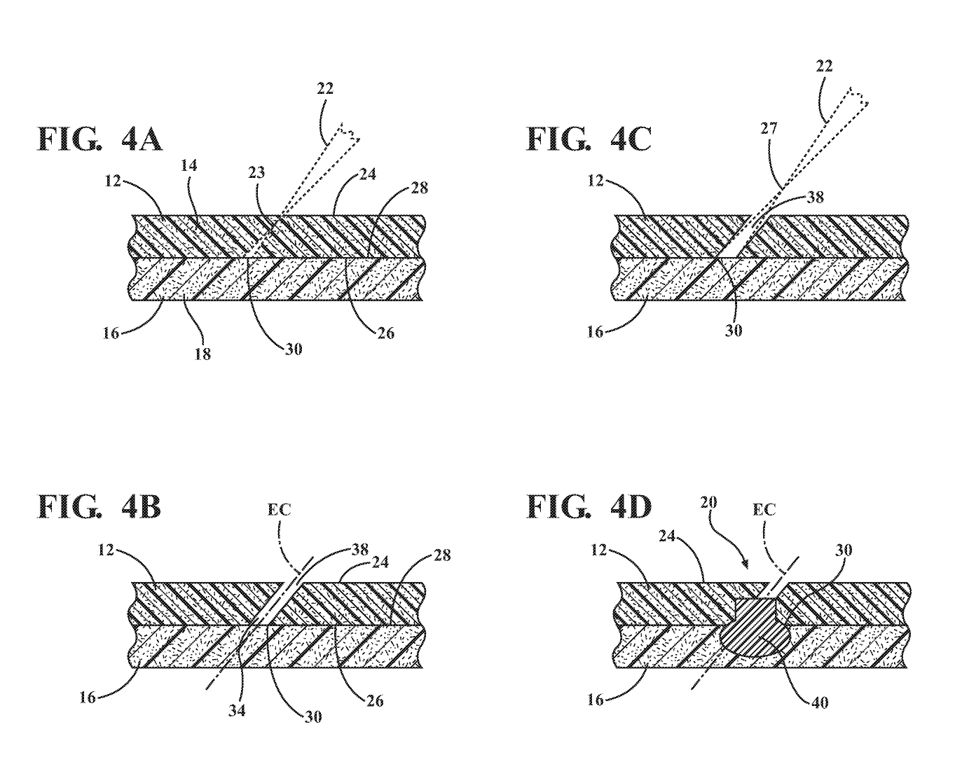

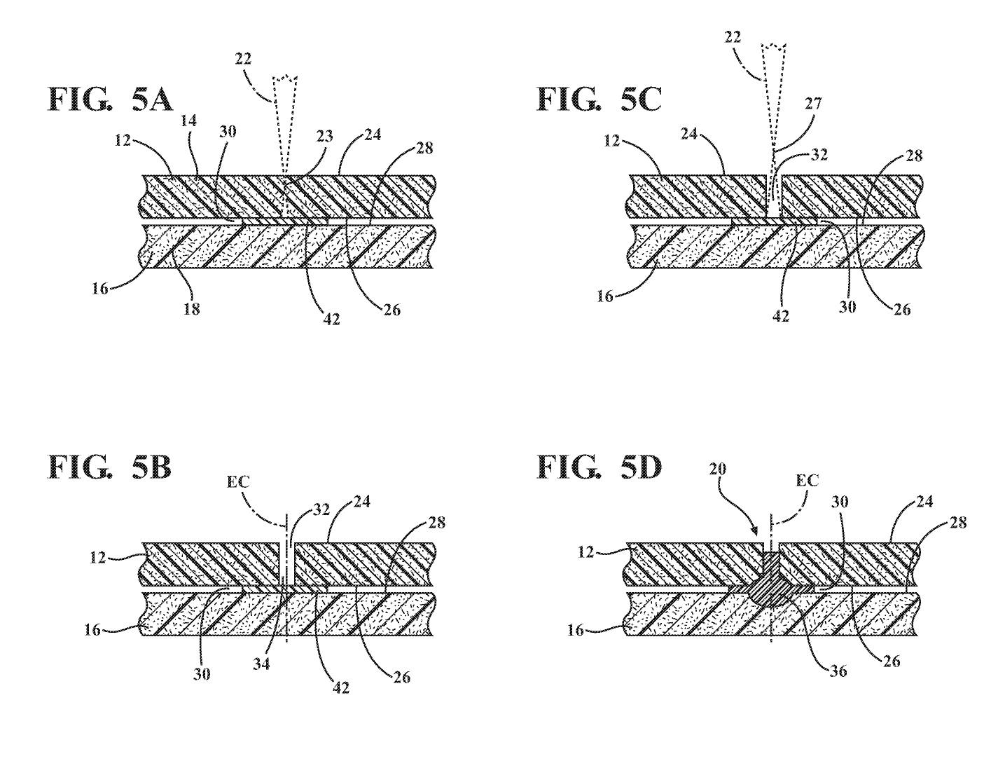

Referring now to FIGS. 3B, 4B, and 5B, the energy channel 32 may have an energy channel axis (Axis EC) defined as the axis of rotation, the central axis, or the longitudinal axis of the energy channel 32, as shown. The energy channel axis (Axis EC) may be normal to the first surface 26 of the first part 12, as shown in FIGS. 3B and 5B. Alternatively, the energy channel axis (Axis EC) may be not normal or angled relative to the first surface 26, as shown in FIG. 4B resulting in an angled energy channel 38. The angled energy channel 38 may expose larger portions of the first and second materials 14, 18 of the first and second parts 12, 16 to the laser beam 22 during laser welding such that an angled energy channel weld nugget 40 is formed. The angled energy channel weld nugget 40 may be larger, may include more of the first and second materials 14, 18, and may be stronger than the weld nugget 36 resulting from the energy channel 32 that is not angled.

Referring now to FIGS. 2 and 5A-5D, the method 100 may include, at step 104, placing an insert 42 between the first surface 26 of the first part 12 and the second surface 28 of the second part 16. Step 104, placing the insert 42 between the first surface 26 of the first part 12 and the second surface 28 of the second part 16, may be done before or after step 102, forming the energy channel 32.

The insert 42 may extend at least across the end opening 34 of the energy channel 32, as shown. The insert 42 may include a thermoplastic material. Welding 110 the second part 16 to the first part 12 via laser heating may include laser heating of the thermoplastic material of the insert 42 such that the materials of the first part 12, the second part 16, and the insert 42 fuse to form the weld nugget 36. The thermoplastic material of the insert 42 may improve the strength of the weld nugget 36. The thermoplastic material of the insert 42 may be the same or similar to the thermoplastic materials of the first and second materials 14, 18. The thermoplastic material of the insert 42 may melt at a lower temperature than the thermoplastic materials of the first and second materials 14, 18.

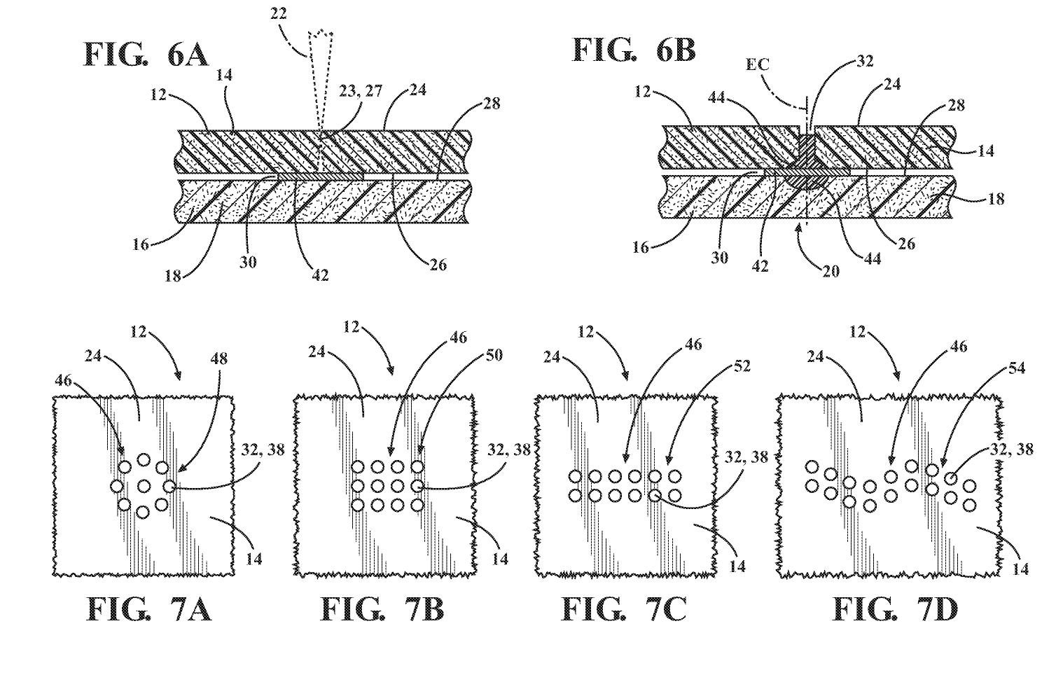

Referring now to FIGS. 2 and 6A-6B, the insert 42 may include a metal material. At step 110, welding the second part 16 to the first part 12 via laser heating may include laser heating of the metal material of the insert 42 such that the materials of the first and second parts 12, 16 are heated by the insert 42 and form a plurality of bonding nuggets 44 attached to the insert 42 such that the first part 12 is attached to the second part 16 via the insert 42 and the plurality of bonding nuggets 44. The plurality of bonding nuggets 44 may be attached to the insert 42 via a chemical bond. The plurality of bonding nuggets 44 may attach the first and second parts 12, 16 to the metal insert 42 such that the first part 12 is attached to the second part 16. The plurality of bonding nuggets 44 may also fuse (not shown) to form a weld nugget 36 outside of the boundaries of the insert 42.

At step 110, the insert 42 including the metal material may be laser heated to a higher temperature than could be achieved by laser heating the first and second materials 14, 18 alone. The higher temperature at the weld interface 30 may allow the laser weld 20 with the insert 42 including the metal material to be completed more rapidly than the laser weld 20 without the insert 42 including the metal material. The insert 42 including the metal material may allow the weld interface 30 to be heated to approximately 1000 degrees Centigrade during laser welding compared to approximately 200 to 300 degrees Centigrade for the first and second materials 14, 18 alone. The insert 42 including the metal material may permit step 102, forming the energy channel 32, 38, and step 110, welding the second part 16 to the first part 12, to occur during a single burst of electromagnetic energy of the laser beam 22.

Referring now to FIGS. 1, 2, and 7A-7D, at step 102, forming the energy channel 32, 38 may include forming a multiplicity of energy channels 32, 38. At step 110, welding may include forming a multiplicity of weld nuggets 36, 40, 44, attaching the first part 12 to the second part 16. The multiplicity of energy weld nuggets 36, 40, 44 may increase the strength of the laser weld 20.

The multiplicity of energy channels 32, 38 may be formed in a pattern 46 including one of a circular pattern 48, as shown if FIG. 7A, a rectangular pattern 50, as shown in FIGS. 1 and 7B, a linear pattern 52, as shown in FIG. 7C, and a cured or wave pattern 54, as shown in FIG. 7D. The pattern 46 for the multiplicity of energy channels 32, 38 may include other configurations. The specific pattern 46 for the multiplicity of energy channels 32, 38 may be selected to meet the geometric requirements of the parts 12, 16 and the performance requirements of the laser weld 20. An extended liner pattern 52 or an extended curved or wave pattern may be used to achieve a continuous or line weld (not shown).

Referring now to FIGS. 1-7D, at step 102, forming the energy channel 32, 38 may include forming the multiplicity of energy channels 32, 38 simultaneously using one laser device with split beam and scanning technology. At step 110, welding may include forming a multiplicity of weld nuggets 36, 40, 44 simultaneously, attaching the first part 12 to the second part 16 using one laser device with split beam and scanning technology. The multiplicity of weld nuggets 36, 40, 44 may be formed proximate to the end opening 24 of the each of the multiplicity of energy channels 32, attaching the first part 12 to the second part 16.

While the best modes for carrying out the disclosure have been described in detail, those familiar with the art to which this disclosure relates will recognize various alternative designs and embodiments for practicing the disclosure within the scope of the appended claims.

1. A method for laser welding of non-transmissive composite materials, comprising:
forming an energy channel having an end opening and extending through a first part made of a first material; and
welding a second part made of a second material to the first part via laser heating of the materials of the first and second parts proximate to the end opening of the energy channel such that the materials of the first and second parts fuse to form a weld nugget, attaching the first part to the second part.

2. The method of claim 1, further comprising positioning the first part relative to the second part such that a first surface of the first part is proximate to a second surface of the second part adjacent to the end opening of the first part.

3. The method of claim 1, further comprising clamping the first part to the second part such that a first surface of the first part is in contact with a second surface of the second part adjacent to the end opening of the first part.

4. The method of claim 1, wherein the first material is non-transmissive to laser energy.

5. The method of claim 4, wherein the first material is a carbon fiber reinforced thermoplastic composite material.

6. The method of claim 4, wherein the second material is non-transmissive to laser energy.

7. The method of claim 1, wherein the second material is the same as the first material.

8. The method of claim 1, wherein forming the energy channel includes laser ablation of the first material of the first part.

9. The method of claim 1, wherein forming the energy channel includes one of molding, drilling, and water jet cutting.

10. The method of claim 1, wherein the energy channel has an axis; and
wherein the axis of the energy channel is normal to the first surface.

11. The method of claim 1, wherein the energy channel has an axis; and
wherein the axis of the energy channel is not normal to the first surface.

12. The method of claim 1, further comprising placing an insert between a first surface of the first part and a second surface of the second part, extending at least across the end opening of the energy channel.

13. The method of claim 12, wherein the insert includes a thermoplastic material; and
wherein welding the second part to the first part via laser heating includes laser heating of the thermoplastic material of the insert such that the materials of the first part, the second part, and the insert fuse to form the weld nugget.

14. The method of claim 12, wherein the insert includes a metal material; and
wherein welding the second part to the first part via laser heating includes laser heating of the metal material of the insert such that the materials of the first and second parts are heated by the insert and form a plurality of bonding nuggets attached to the metal insert.

15. The method of claim 1, wherein forming the energy channel includes forming a multiplicity of energy channels; and
wherein welding includes forming a multiplicity of weld nuggets, attaching the first part to the second part.

16. The method of claim 15, wherein the multiplicity of energy channels are formed in a pattern including one of a circular pattern, a rectangular pattern, a linear pattern, and a wave pattern.

17. The method of claim 1, wherein forming the energy channel includes forming a multiplicity of energy channels simultaneously; and
wherein welding includes forming a multiplicity of weld nuggets simultaneously, attaching the first part to the second part.

18. A method for laser welding of non-transmissive composite materials, comprising:
forming an energy channel extending through a first part and having an end opening;
positioning the first part relative to a second part such that a first surface of the first part is proximate to a second surface of the second part adjacent to the end opening of the energy channel; and
welding the second part to the first part via laser heating of the first and second parts proximate to the end opening of the energy channel such that the first and second parts fuse to form a weld nugget;
wherein the first part is made of a first material that is non-transmissive to laser energy and includes a thermoplastic material; and
wherein the second part is made of a second material that includes a thermoplastic material.

19. A method for laser welding of non-transmissive composite materials, comprising:
forming an energy channel extending through a first part and having an end opening;
placing an insert between a first surface of the first part and a second surface of a second part; and
welding the second part to the first part via laser heating of the insert, the first part, and the second part proximate to the end opening of the energy channel such that at least one weld nugget is formed, attaching the first part to the second part;
wherein the first part is made of a first material that is non-transmissive to laser energy and includes a thermoplastic material; and
wherein the second part is made of a second material that includes a thermoplastic material.

20. The method of claim 19, wherein the insert includes a metal material;
wherein forming the energy channel and welding the second part to the first part occurs during a single burst of laser energy; and
wherein the at least one weld nugget attaches the first and second parts to the metal insert, attaching the first part to the second part via the metal insert.
